(19) United States
(12) Patent Application Publication
(10) Pub. No.: US 2026/0153732 A1
(43) Pub. Date: Jun. 4, 2026

(54) EMBEDDED WAVEGUIDE STRUCTURES FOR EYE TRACKING

(71) Applicant: GOOGLE LLC, Mountain View, CA (US)

(72) Inventors: Alexander Koshelev, Kirkland, WA (US); Christophe Peroz, Zollikon (CH)

(21) Appl. No.: 19/406,010

(22) Filed: Dec. 2, 2025

Related U.S. Application Data
(60) Provisional application No. 63/726,730, filed on Dec. 2, 2024.

(51) Int. Cl. G02B 27/00; G02B 6/26; G02B 6/34; G02B 27/01

(52) U.S. Cl. CPC G02B 27/0093; G02B 6/262; G02B 6/34; G02B 27/0081; G02B 27/0172; G02B 2027/0138; G02B 2027/014

(57) ABSTRACT

A reflective waveguide includes a substrate comprising a plurality of partially-reflective prisms and an input hot mirror disposed at one or more partially-reflective prisms of the substrate. The input hot mirror is reflective to infrared light and substantially transmissive to visible light and is configured to incouple infrared light into the reflective waveguide. The substrate further comprises an incoupler configured to incouple display light into the reflective waveguide, an outcoupler comprising a first subset of the plurality of partially-reflective prisms and configured to outcouple the display light from the reflective waveguide, and an exit pupil expander comprising a second subset of the plurality of partially-reflective prisms and configured to guide the display light from the incoupler to the outcoupler.

### CROSS-REFERENCE TO RELATED APPLICATIONS

The present application is a non-provisional conversion application of U.S. Provisional Ser. No. 63/726,730 , entitled “Embedded Waveguide Structures for Eye Tracking in AR Glasses” and filed on Dec. 2, 2024, the entirety of which is incorporated by reference herein.

### BACKGROUND

Eye tracking is often employed in near-eye display (NED) systems for augmented reality (AR), virtual reality (VR), or mixed reality (MR). Eye tracking enables various functionalities, such as user input, foveated rendering, and display calibration based on pupil position and gaze. Conventional eye-tracking systems typically rely on imaging the eye using an infrared (IR) camera. In such systems, the eye is illuminated using IR light sources, and a small IR camera captures images of the eye surface. These images are then processed to extract eye position or gaze information using various algorithms, including machine learning (ML) or other artificial intelligence (AI) models.

The accuracy and performance of image-based eye-tracking systems are generally highest when the imaging camera is positioned directly in front of the eye, along the eye's optical axis. However, this optimal camera placement presents a challenge for NED systems with optical see-through displays, as placing a physical camera in this location would obstruct the user's field of view. To address this issue, existing NED displays with see-through optical displays (referred to herein generally as “AR glasses” or, more generally, “glasses” for ease of reference, although without intent to limit to solely AR implementations or eyeglass form factor implementations) typically employ one of two approaches for camera positioning. The first approach involves placing the camera in the glasses frame in front of the eye, providing an unobstructed view but necessitating a large imaging angle that deviates significantly from the eye's optical axis. The second approach utilizes a separate hot mirror (that is, an optical structure that substantially reflects IR light while substantially transmitting visible light) located on the frame to reflect the eye image to a camera positioned elsewhere. While this method can reduce the viewing angle, the line of sight to the eye from the hot mirror position on the frame may still be easily obstructed by facial features or hair. These conventional approaches thus often result in compromises between eye tracking accuracy, system complexity, and user comfort. Additionally, the use of multiple cameras or complex optical systems to capture eye images from various angles can lead to increased power consumption, larger form factors, and higher costs for NED systems.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a block diagram of a near-eye display (NED) system employing an eye-tracking system with an input hot mirror embedded in a reflective waveguide for guiding IR light from an eye to an eye-tracking camera via the reflective waveguide in accordance with some embodiments.

FIG. 2 illustrates a plan view of the reflective waveguide of FIG. 1 in accordance with some embodiments.

FIG. 3 illustrates a cross-section view of a portion of the reflective waveguide of FIGS. 1 and 2 in accordance with some embodiments.

FIG. 4 illustrates a perspective view of an eye-side substrate of the reflective waveguide of FIGS. 1 to 3 in accordance with some embodiments.

FIG. 5 illustrates a cross-section view of the reflective waveguide of FIGS. 1 to 3 in accordance with some embodiments.

FIG. 6 illustrates a cross-section view of an alternative implementation of the reflective waveguide with an embedded hot mirror in a different orientation in accordance with some embodiments.

FIG. 7 illustrates a plan view of an alternative implementation of a reflective waveguide with an embedded hot mirror located in a position closer to an eye-tracking outcoupler of the reflective waveguide in accordance with some embodiments.

FIG. 8 illustrates a rear perspective view of an eyewear display device implementing the NED system of FIG. 1 in accordance with some embodiments.

### DETAILED DESCRIPTION

The following describes systems and methods for eye tracking in an NED system employing a see-through optical element (e.g., “AR glasses”) in which the infrared (IR) light reflected from the eye is incoupled (or “captured”) by a mirror embedded inside the reflective waveguide and propagated through the reflective waveguide for output toward an eye-tracking camera. Conventional eye-tracking systems for AR glasses use one or several cameras that image the eye. Because of form factor limitations of AR glasses, these cameras necessarily observe the eye at oblique angles, which reduces eye tracking accuracy. In contrast, the eye-tracking systems described herein mitigate this issue by utilizing the achromatic nature of reflective waveguides in order to position a virtual camera directly in front of the eye via the embedded mirror.

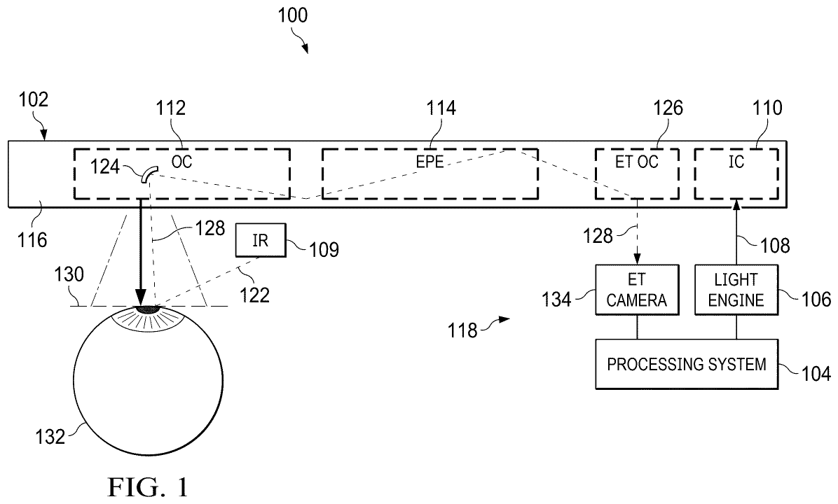

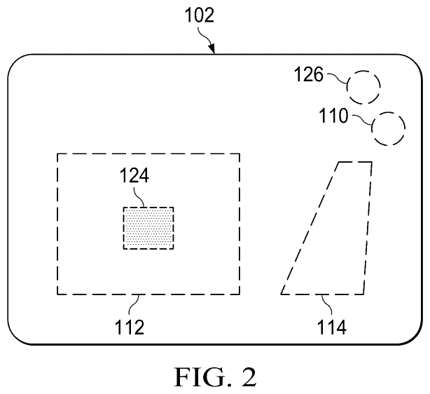

FIGS. 1 and 2 together illustrate a near-eye display (NED) system 100 utilizing a reflective waveguide with an embedded hot mirror for incoupling and propagating IR light reflected from a user's eye in accordance with some embodiments. FIG. 1 depicts a block diagram of the NED system 100, which includes a reflective waveguide 102 (illustrated via a cross-section view in FIG. 1), a processing system 104 and a light engine 106. The processing system 104 includes one or more central processing units (CPUs), graphics processing units (GPUs), accelerator processing units (APUs), or other processors, memory, input/output (I/O) devices, and the like, to provide processing functionality as described herein. The light engine 106 includes one or more light projectors or displays, such as a microLED (uLED) display, liquid crystal on silicon (LCoS) display, laser projector, and the like, and is configured to generate and output display light 108 representative of graphical content (e.g., imagery, icons, video, a graphical user interface (GUI), and the like) specified by the processing system 104.

As also shown in more detail with a plan view of the reflective waveguide 102 as shown in FIG. 2, the reflective waveguide 102 is configured to incouple, or receive, the display light 108 via an incoupler (IC) 110 of the waveguide 102 and propagate the incoupled display light to an outcoupler (OC) 112 of the waveguide 102, which outcouples, or outputs, the propagated display light toward an eye 132 of a user of the NED system 100. Additionally, in at least one embodiment, the reflective waveguide 102 employs an exit pupil expander (EPE) 114 in the light path between the IC 110 and OC 112, or in combination with the OC 112, in order to increase the dimensions of the display exit pupil. As waveguide 102 is a reflective waveguide, each of the IC 110, OC 112, or EPE 114 is implemented in the substrate 116 of the waveguide 102 as a corresponding subset of one or more semi-transparent prisms (prism mirrors) configured to partially reflect incident display light (that is, light in the visible spectrum), and wherein the display light is propagated between louvered mirrors and between the IC 110, EPE 114, and OC 112 via total internal reflection (TIR) between opposing surfaces of the substrate 116. Note that the shapes and relative dimensions of the IC 110, EPE 114, OC 112, and hot mirror 124 (described below) are shown in FIGS. 1 and 2 are merely for illustrative purposes to facilitate their depiction and the description of their operation.

The NED system 100 further includes an eye-tracking system 118 that includes one or more infrared (IR) light sources 120, such as IR LEDs or IR vertical external cavity surface emitting lasers (VECSELs), to illuminate the eye 132 with IR light 122 and one or more eye-tracking (ET) cameras 134 to capture one or more images of the eye 132 based on IR light reflected by the eye 132. The processing system 104 then analyzes the captured image(s) of the eye 132 to determine a current eye position and/or gaze direction, and from this information controls one or more operations of the NED system 100, such as by using gaze direction to determine an area of focused rendering or for eye-controlled user input, and the like.

As noted above, in a conventional eye tracking approach, either the ET camera is placed where it has a direct view of the user's eye or a hot mirror is placed on the eye-facing surface of the waveguide so as to reflect an IR image of the eye from the surface of the waveguide to the camera, which is focused on the hot mirror. The first approach requires a relatively large viewing angle of the user's eye with the camera's line of sight to the eye being relatively far from the axis of the eye, both of which can impair eye tracking accuracy. The second approach provides a narrower viewing angle, but is more at risk of obstruction, such as by hair of the user.

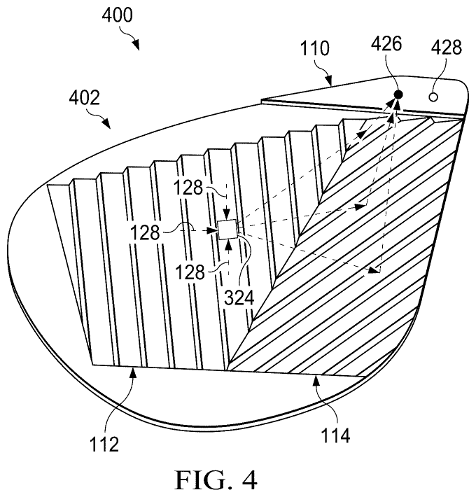

In contrast, embodiments of the eye-tracking system 118 of the NED system 100 utilize the reflective waveguide 102 itself to capture reflected IR light from the eye 132 and propagate this IR light through the waveguide 102 for output to the one or more ET cameras 134. In particular, the eye-tracking system 118 employs an input hot mirror 124 and an eye-tracking (ET) OC 126 embedded in the reflective waveguide 102. The input hot mirror 124, as a hot mirror, is reflective to IR light and substantially transmissive for visible light, and operates to incoupled reflected IR light 128 from the eye 132 into the reflective waveguide 102, which propagates or otherwise guides the captured reflected IR light 128 internally through the waveguide 102 to the ET OC 126. The ET OC 126 is likewise reflective to IR light and operates to output, or outcouple, the guided reflected IR light 128 in the direction of the ET camera 134, which is focused on, or otherwise targeted to, the ET OC 126. The light path of the reflected IR light 128 through the waveguide 102 includes the EPE 114, and thus the reflective prisms of the EPE 114 likewise can be used to guide light from the input hot mirror 124 to the ET OC 126 (as described in greater detail below with reference to FIG. 4).

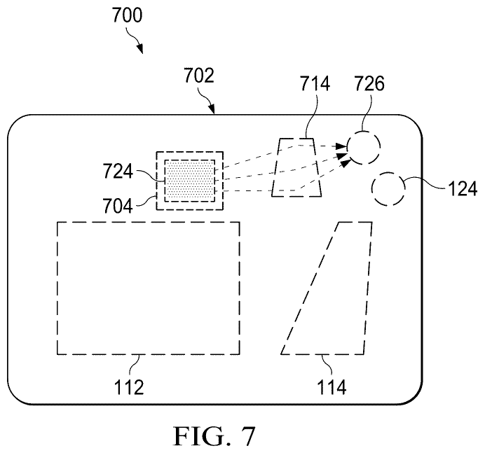

As explained above, the reflective waveguide 102 includes a plurality of prisms, and the OC 112 of the reflective waveguide 102 is, in embodiments, composed of a subset of these prisms, that is, as a set of partially-reflective mirrors formed on surfaces of a corresponding subset of prisms formed in the substrate. In some embodiments, the input hot mirror 124 is composed of an IR-reflective/visible-light-transmissive structure formed on one or more of the prisms of this subset of prisms of the OC 112. As such, the input hot mirror 124 can be formed as a hot mirror on a single prism or as a set of hot mirrors formed on a two or more mirrors that together serve as the input hot mirror 124. In other embodiments, as described below with reference to FIG. 7, the input hot mirror 124 can be formed as a hot mirror on one or more prisms of a separate subset of one or more prisms employed specifically for the input hot mirror 124.

One challenge for the implementation of an eye-tracking system is that a pupil-replicating waveguide typically cannot transfer non-flat wavefronts. To illustrate, assume a diverging beam is coupled into the reflective waveguide 102 through the input hot mirror 124 and is outcoupled through the ET OC 126. The nature of a pupil-replicating waveguide, such as the reflective waveguide 102, is that the alignment between the beam and the ET OC 126 is unknown, due to multiple bounces and the fact that the alignment depends significantly on the field angle. As a result, a lens placed in front of the output pupil cannot focus every possible position of the output wavefront.

Because a reflective waveguide typically can only transfer flat wavefronts (collimated beams), in embodiments of the eye-tracking system 118, the input hot mirror 124 is implemented as a curved input mirror in order to collimate the reflected IR light 128 coming from the image plane 130 containing the eye 132. Thus, the input hot mirror 124 acts as an aperture stop. An eye-tracking imaging system typically seeks to have a fairly large field of view (FOV) (e.g., ˜30°-80°) as well as a long depth of field, since different portions of the eye might appear at different distances from the lens. As a result, the input hot mirror 124 can benefit from being relatively small in size (e.g., 0.5-5 mm in diameter) in order to reduce aberrations of a large FOV image as well as to increase the depth of field. Moreover, the size of the eye-tracking camera 134 should also be relatively small as well in order to fit into the form factor of the frame containing the NED system 100. Therefore, in order to relay the eye image between a small input aperture (curved hot mirror 124) and a small eye tracking camera, the reflected IR light 128 can be expanded by a mirror array (e.g., the EPE 114) composed of parallel mirrors formed in a different subset of prisms of the plurality of prisms of the reflective waveguide 102. Thus, in sum, in some embodiments, the eye-tracking system 118 utilizes some or all of the following features: a curved hot mirror (reflects IR light, transmits visible light) embedded in the waveguide 102 in front of the user's eye 132 and which collimates the light from the image plane 130 and couples it into the waveguide, and which is relatively small in size (e.g., 0.5-5 mm in diameter); and an EPE mirror array (EPE 118) that includes two or more parallel semi-transparent mirrors used to transfer a portion of light from the input hot mirror 124 to the ET camera 134.

Generally, reflective waveguides, such as the reflective waveguide 102, may be formed from a substrate composed of plastics or other polymers using various manufacturing techniques, such as injection molding, casting (ultraviolet, thermal, or hybrid), milling, and the like. Typically, two individual workpieces representing the world-side and eye-side, respectively, of a reflective waveguide to be formed are molded, cast, shaped, or otherwise formed separately, and contain corresponding sets of prisms that conform with the prisms of the other workpiece. Partially-reflective mirrors are deposited or otherwise formed on corresponding prism surfaces on one of the workpieces, and then the two workpieces are bonded together or otherwise adjoined to form the reflective waveguide.

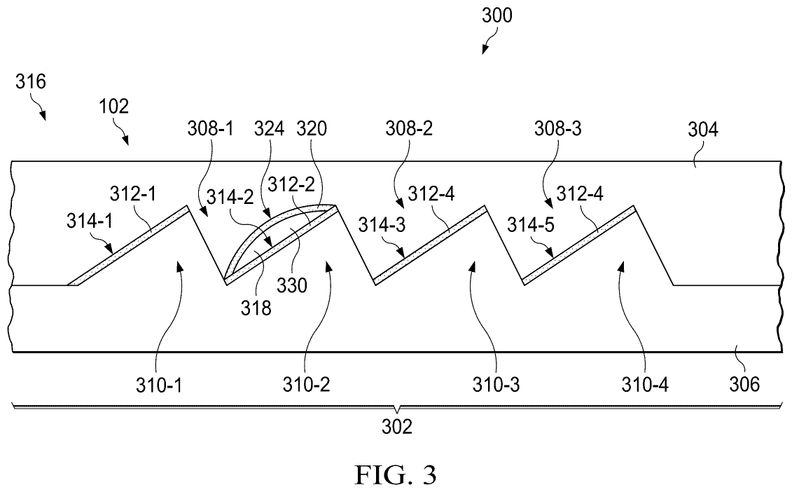

For example, FIG. 3 illustrates an example cross-section view 300 of a section 302 of the reflective waveguide 102 manufactured in this manner, with the section 302 comprising the section of the reflective waveguide 102 that implements the hot mirror 124, such as the OC 112. In implementations, a world-side workpiece 304 and a separate eye-side workpiece 306 are formed via molding, casting, milling, or the like. In some embodiments, the workpieces 304 and 306 are formed from one or more plastics or other polymers. The workpiece 304 has a plurality of prisms 308 (e.g., prisms 308-1 to 308-3 formed at the eye-facing surface, and the workpiece 306 has a corresponding plurality of prisms 310 (e.g., prisms 310-1 to 310-4) formed at the world-facing surface, such that the plurality of prisms 308 are conformal with the plurality of prisms 310, and vice versa, when the workpieces 304, 306 are adjoined. One or more mirror coatings 312 (e.g., mirror coatings 312-1 to 312-4) are deposited or otherwise formed at the angled facets of some or all of the prisms 310 to form a plurality of semi-reflective prism mirrors 314 (e.g., prism mirrors 314-1 to 314-4 for prisms 310-1 to 310-4, respectively) when the two workpieces 304, 306 are adjoined. Such coatings can include, for example, a multilayer dielectric coating with partially reflective properties for light at the wavelengths of interest. To illustrate, the mirror coatings 312 may be implemented as, for example, 10 to 13 layers alternating between ZrO₂ and SiO₂ layers. In a conventional approach, the workpieces 304 and 306 would then be bonded together or otherwise adjoined using optical adhesive, fusion via partial melting, and the like, thereby forming a substrate 316 of the resulting waveguide, with the resulting prism mirrors 314 forming the partially-reflective prisms of one or more of the OC, EPE, or IC of the waveguide.

However, for the reflective waveguide 102, the fabrication of the semi-reflective prism mirrors 314 presents an opportunity to also fabricate the input hot mirror 124. Accordingly, in some embodiments, a region of the prism surface of each of one or more adjacent prisms 308 is used to form a curved surface instead of a planar prism surface. To illustrate, in the example of FIG. 3, a portion of a facet of the prism 308-1 is formed with a curved (concave) surface 318 instead of a planar surface as found in, for example, the corresponding facet of the adjacent prism 308-2. The curved surface 318 may be formed as part of the same fabrication process as the other surfaces of the other prisms, such as part of the original injection molding or casting process, or the curved surface 318 may be formed via a subtractive process (e.g., diamond turning or other milling). The curved surface 318 is then coated with one or IR-reflective materials 320, such as a multilayer dielectric mirror, resulting in a curved input hot mirror 324 (one embodiment of the input hot mirror 124). The multilayer dielectric mirror may be composed of, for example, a layer stack design with interleaving layers of high-index and low-index materials. Such high-index materials can include, for example, one or more of TiO₂, ZrO₂, SiN, Ta₂O₅, and the low-index materials can include, for example, SiO2 or SiON. The workpieces 304, 306 are then bonded together using an optical adhesive. The gap 330 resulting from the mismatch in shapes between the curved surface 320 in the facet 308-1 of workpiece 304 and the facing planar surface of the mirror 314-2 of facet 310-2 of workpieces 306 then may be filled with a relatively thick optical adhesive layer, thereby filling this gap 330. Further, in some embodiments, use of this relatively thick optical adhesive layer (e.g., between 5-50 μm) in the resulting gap 330 can help ensure that the reflectivities of the prism mirrors add up incoherently with respect to the typical display spectrum of the light source (e.g., a LED light source).

In the illustrated example, the input hot mirror 324 is no larger than the entire facet of corresponding prism 308-1 (e.g., covers only a portion of the entire length of the prism facet), as shown subsequently with reference to FIG. 4, and thus may be implemented using a single prism facet. In other embodiments, the input hot mirror is larger than one prism and is thus split between two or more adjacent prisms in a manner similar to a Fresnel lens. For example, in the example of FIG. 3, the input hot mirror 324 could be implemented instead by using IR-mirror-coated curved facet surfaces on corresponding portions of each of adjacent prisms 308-1, 308-2, and 308-3. Moreover, in some embodiments, a corrective lens may be positioned between the eye and the waveguide 102. In this case, the curvature of the input hot mirror may be adjusted to account for the light traveling through the corrective lens.

FIG. 4 depicts a perspective view 400 of the eye-side half 402 of the substrate 316 (that is, the workpiece 304 in final form) of the reflective waveguide 102 and an example location of the embedded input hot mirror 324 (as one embodiment of the input hot mirror 124) in accordance with embodiments. As shown, different parts of the eye image propagate in the waveguide in different directions. The array of prism mirrors of the EPE 114 helps ensure that for every portion of the IR eye image represented in the reflected IR light 128 incoupled by the input hot mirror 324, there is at least one EPE mirror that would reflect that IR light towards the eye-tracking camera 134 via the ET OC 126 (as represented by eye tracking pupil 426) of the IC 110. An advantage of a reflective waveguide, as opposed to diffractive waveguide, for the eye tracking imaging is that a reflective waveguide is mostly achromatic and thus the same mirror angles can be used to guide red-green-blue (RGB) display light from the IC 110 (as represented by the display light pupil 428) to the eye 132, as well as guide the IR image (reflected IR light 128) of the eye 132 towards the ET OC 126 (as represented by eye tracking pupil 426) of the IC 110 for the eye tracking camera 134.

To this end, the EPE mirror coating, in some embodiments, is optimized to reflect both RGB light and the IR light. In other embodiments, the EPE coating on one section (e.g., the top section) of each EPE prism facet involved in both RGB display light propagation and IR light propagation is optimized for the RGB light, and the coating on another section (e.g., the bottom or top) of the EPE prism is optimized for IR light. As noted above, the relatively large distance (e.g., 5-50 μm) between such coatings through the use of a relatively thick adhesive layer helps ensure that the reflectivities of the coatings add up incoherently.

In some embodiments, the IR mirror is positioned away from the optical axis of the eye and closer to the eye-tracking camera in order to increase the efficiency of the light delivery from the mirror to the camera. In some embodiments, the IR mirror is moved just outside of the existing prism arrays and uses a dedicated EPE mirror array. The angle of this EPE mirror array may be different from the angle of the EPE array for guiding the display light. The EPE mirror coating can also be optimized to reflect both the RGB light and the IR light. In other embodiments, the EPE coating on one part (top or bottom) is optimized for the RGB light and the coating on the other part (bottom or top) is optimized for IR light. The large distance (5-50 μm) between the coatings due to the glue layer ensures that the reflectivities of the coatings add up incoherently.

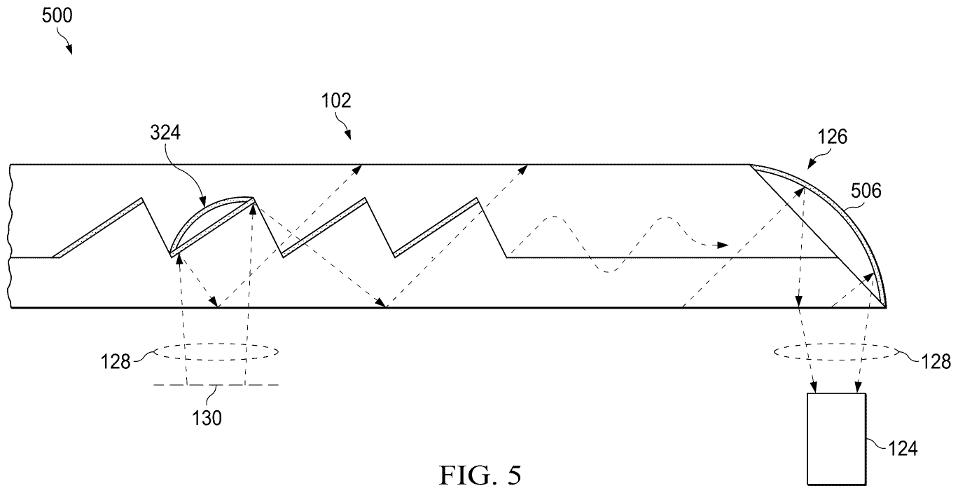

FIG. 5 illustrates a cross-section view 500 of the reflective waveguide 102 of FIG. 3, and includes an implementation of the ET OC 126 in accordance with some embodiments. In the depicted example, the ET OC 126 is implemented as a curved mirror 506 formed at the edge of the reflective waveguide 102, and which is configured to outcouple the reflected IR light 128 towards the eye tracking camera 134. The curved mirror 506 may be formed by, for example, forming a corresponding curved surface at the edge of the substrate during fabrication (e.g., via injection molding or milling), and then coating the curved surface with one or more IR-reflective materials. In some embodiments, the curvature can be optimized to reduce the number of optical elements in the eye tracking camera lens stack. To illustrate, in some embodiments, the eye tracking camera 134 does not have a lens and contains only a camera sensor and, in some cases, an IR filter. The curved mirror 506 thus may be curved in a manner such that focusing of outcoupled IR light onto the camera sensor is fully performed by the curved output mirror 506.

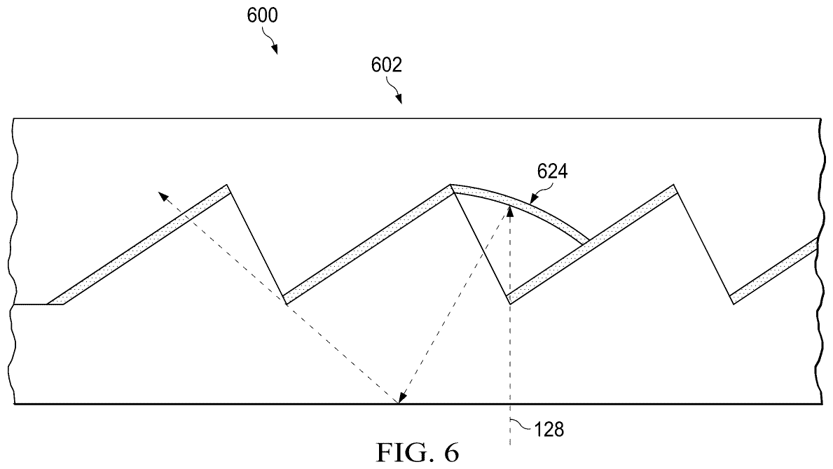

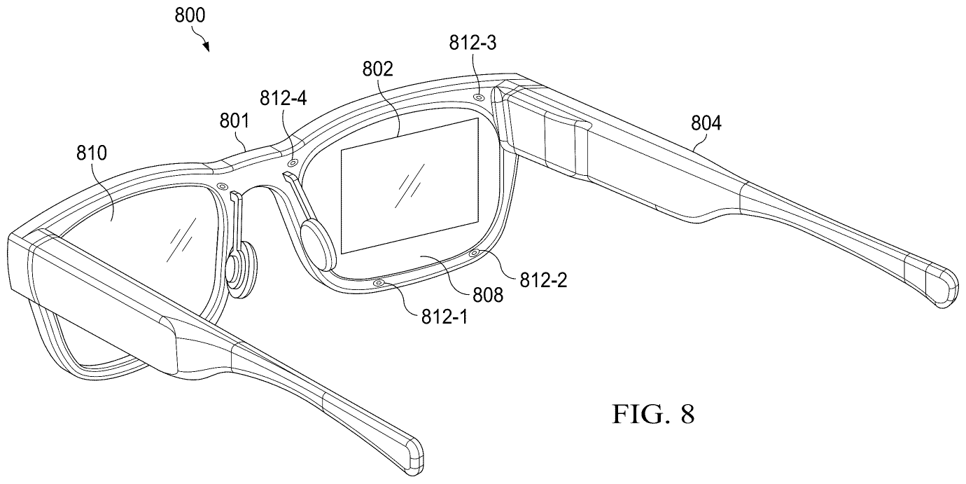

FIG. 6 illustrates a cross-section view 600 of an alternative implementation of the reflective waveguide 602, designated reflective waveguide 602, in accordance with some embodiments. In the depicted implementation, rather than implement an input hot mirror, such as input hot mirror 324, oriented on one or more prism facets so as to reflect IR light in the direction shown in FIG. 3, which is toward the temple region of the reflective waveguide 102 when implemented in a near-eye display device (see FIG. 8), an input hot mirror 624 (one embodiment of input hot mirror 124) can be implemented on one or more prism facets of the OC 112 or EPE 114 so as to reflect IR light in a direction opposite of the direction shown in FIG. 3, that is, to reflect the IR light 128 in the opposite direction, or toward the nasal region of the waveguide 602 when implemented in a near-eye display device. As such, a dedicated EPE in the nasal region (not shown) can be used in order to expand the eye tracking image pupil. This approach can simplify the design of the EPE coating, as balancing of the reflectivities at the IR wavelength of the eye tracking and at the visible wavelength of the display can be avoided.

As described above, in some embodiments, the input hot mirror 124 is implemented close to the optical axis of the eye 132, and thus is implemented using one or more prisms of the OC 112. This position allows the eye-tracking system 118 to have the most direct view of the eye 132 and typically results in more accurate eye tracking. However, this position for the input hot mirror typically results in a relatively large distance between the input hot mirror and the eye tracking OC 126, which negatively impacts the efficiency of light delivery from the input hot mirror to the ET camera 134. To address this, FIG. 7 illustrates a plan view 700 of an alternative reflective waveguide 702 in which an input hot mirror 724 (one embodiment of the input hot mirror 124) is located closer to the eye tracking OC 126 (represented by eye tracking pupil 726), such as in region 704 outside of OC 112 (e.g., “above” OC 112 in the orientation of view 700) and closer to the eye tracking pupil 726 (representing the eye tracking OC 126). Note, however, that the input hot mirror 724 is not limited to this position, but instead may be implemented in other regions outside of the OC 112 as design demands warrant. As this position outside of the OC 112 is not able to utilize the prism mirrors of the EPE 114, the reflective waveguide 702 further may include a dedicated EPE 714 positioned in the light path between the input hot mirror 724 and the eye tracking pupil 726, where the dedicated EPE 714 includes one or more prism mirrors configured to at least partially reflect IR light. The angle of this EPE mirror array may be different from the angle of the EPE array for guiding the display light. In this approach, the efficiency of light delivery from the input hot mirror to the ET camera 134 is improved due to the shortened distance, but at the expense of additional dedicated prism mirrors and a less optimal view angle of the user's eye 132.

FIG. 8 is a diagram illustrating a rear perspective view of an eyewear display device 800 with a glasses form factor for implementing the NED system 100 in accordance with some embodiments. The eyewear display device 800 includes a support structure 801 (e.g., a support frame) to mount to a head of a user and includes an arm 804 that houses the light engine 106 (e.g., microLED, LCoS, laser projector, etc.) configured to project display light 108 representative of images toward the eye 132 of a user, such that the user perceives the projected display light as a sequence of images displayed in a field of view (FOV) area at one or both of lens elements 808, 810 supported by the support structure 801. In some embodiments, the support structure 801 further includes various sensors, such as one or more front-facing cameras, light sensors, motion sensors, accelerometers, and the like, as well as the eye-tracking camera 134 (not shown in FIG. 8).

The support structure 801 can further include one or more radio frequency (RF) interfaces or other wireless interfaces, such as a Bluetooth(TM) interface, a WiFi interface, and the like. The support structure 801 can also include one or more batteries or other portable power sources for supplying power to the electrical components of the NED system 100 of FIG. 1. In some embodiments, some or all of these components are fully or partially contained within an inner volume of support structure 801, such as within the arm 804 of the support structure 801. In the illustrated implementation, the eyewear display system 800 utilizes an eyeglasses form factor. However, the eyewear display device 800 is not limited to this form factor and thus may have a different shape and appearance from the eyeglasses frame depicted in FIG. 1.

One or both of the lens elements 808, 810 are see-through optical elements used by the eyewear display device 800 to provide an AR/MR display in which rendered graphical content generated by the processing system 104 can be superimposed over, or otherwise provided in conjunction with, a real-world view as perceived by the user through the lens elements 808, 810. For example, display light is used to form a perceptible image or series of images that are projected onto the eye of the user via one or more optical elements, including a reflective waveguide 802 (e.g., an embodiment of one or more of reflective waveguide 102, 602, or 702) formed at least partially in the corresponding lens element. One or both of the lens elements 808, 810 thus includes the reflective waveguide 802 that routes display light received by the incoupler (IC) 110 (FIG. 1) to the OC 112 via the EPE 114, and the OC 112 outputs the display light toward an eye (e.g., eye 132) of a user of the eyewear display device 800. Each of the lens elements 808, 810 is sufficiently transparent to allow a user to see through the lens elements to provide a field of view of the user's real-world environment, such that the image appears superimposed over at least a portion of the real-world environment.

In some embodiments, the eyewear display device 800 utilizes the eye-tracking system 118 in which IR light (e.g., IR light 122, FIG. 1) is emitted from one or more IR light sources (e.g., IR emitters 812-1, 812-2, 812-3, 812-4, embodiments of IR light source 109) facing a corresponding eye of the user and the waveguide 802 implemented in a corresponding lens element 808, 810 is a reflective waveguide that utilizes an embedded input hot mirror (e.g., input hot mirror 124, 324, 624, or 724) to capture IR light (e.g., reflected IR light 128) reflected from the eye and this captured reflected IR light is then guided by the waveguide to the ET camera 134 located in the temple or elsewhere in the lateral side of the support structure 801 of the eyewear display device 800. The imagery of the eye 132 represented by this conveyed reflected IR light is then processed by the processing system 104 to determine one or more of pupil location or gaze direction, and from this information, control one or more operations of the NED system 100.

It will be appreciated that the above-described approaches of FIGS. 1-8 are readily combinable with the standard eye illumination techniques, such as:
using a number of IR sources hidden in the frame of the glasses;
using a single IR source located in the temple arm and reflected from a hot mirror, while the hot mirror may be located on the world side of the curved IR imaging mirror in order not to block the light reflected from the eye. For example, the outer total internal reflection (TIR) surface of the waveguide could have an IR reflective coating;
using IR sources coupled into the waveguide and gradually outcoupled via the reflective waveguide mirror arrays.

One general aspect includes an eye-tracking system for an NED system. The eye-tracking system also includes an eye tracking camera positioned in a temple of the NED system; a reflective waveguide configured to be positioned in front of a user's eye; and a curved hot mirror embedded within the reflective waveguide, the curved hot mirror configured to reflect IR light and transmit visible light so that IR light reflected from the user's eye is captured and coupled into the reflective waveguide, and where the reflective waveguide is configured to guide the coupled IR light to the eye tracking camera.

Implementations may include one or more of the following features. The eye-tracking system, where the reflective waveguide may include an expanded pupil element (EPE) mirror array that may include a plurality of parallel semi-transparent mirrors configured to transfer a portion of the coupled IR light from the curved hot mirror to the eye tracking camera. The curved hot mirror has a diameter or maximum extent between 0.5 mm and 5 mm. The reflective waveguide may include a first section and an overlying second section, the first section and second section having complementary prism arrays. The reflective waveguide may further include a mirror coating disposed between corresponding surfaces of the complementary prism arrays. The eye-tracking system may include an optical adhesive layer between the corresponding surfaces of the complementary prism arrays. The curved hot mirror is configured to focus the coupled IR light onto a sensor of the eye tracking camera. The hot mirror is offset from the axis of the eye of a user. Implementations of the described techniques may include hardware, a method or process, or computer software on a computer-accessible medium.

One general aspect includes a near-eye display. The near-eye display system also includes a frame, a light source, one or more infrared (IR) illumination sources, and the eye-tracking system. Implementations may include one or more of the following features. A method for operating the near-eye display system may include:
positioning the reflective waveguide in front of a user's eye; capturing infrared IR light reflected from the user's eye and coupling the captured IR light into the reflective waveguide using the curved hot mirror; and guiding the coupled IR light through the reflective waveguide to an eye tracking camera positioned in a temple of the near-eye display system.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified, and all such variations are considered within the scope of the disclosed subject matter. Accordingly, the protection sought herein is as set forth in the claims below.

What is claimed is:

1. A reflective waveguide comprising:
a substrate comprising a plurality of partially-reflective prisms; and
an input hot mirror disposed at one or more partially-reflective prisms of the substrate, the input hot mirror reflective to infrared light and transmissive to visible light and configured to incouple infrared light into the reflective waveguide.

2. The reflective waveguide of claim 1, wherein the input hot mirror is a curved hot mirror configured to collimate the incoupled infrared light.

3. The reflective waveguide of claim 2, wherein the curved hot mirror is implemented on a curved portion of a facet of at least one partially-reflective prism of the substrate.

4. The reflective waveguide of claim 3, wherein the reflective waveguide includes a planar partially-reflective mirror formed on a planar prism surface facing the facet with the curved portion.

5. The reflective waveguide of claim 1, wherein the substrate comprises:
an incoupler configured to incouple display light into the reflective waveguide;
an outcoupler comprising a first subset of the plurality of partially-reflective prisms and configured to outcouple the display light from the reflective waveguide; and
an exit pupil expander comprising a second subset of the plurality of partially-reflective prisms and configured to guide the display light from the incoupler to the outcoupler.

6. The reflective waveguide of claim 5, wherein the input hot mirror is implemented at a portion of a facet of one or more partially-reflective prisms of the first subset.

7. The reflective waveguide of claim 6, further comprising:
an eye-tracking outcoupler; and
wherein:
the input hot mirror is configured to guide the incoupled infrared light toward the exit pupil expander;
the exit pupil expander is configured to guide the incoupled infrared light toward the eye-tracking outcoupler; and
the eye-tracking outcoupler is configured to outcouple the incoupled infrared light from the reflective waveguide.

8. The reflective waveguide of claim 7, wherein the second subset of partially-reflective prisms are configured to at least partially reflect both visible light and infrared light.

9. The reflective waveguide of claim 7, wherein the eye-tracking outcoupler comprises a curved mirror configured to reflect infrared light.

10. The reflective waveguide of claim 9, wherein the curved mirror is configured to collimate the reflected infrared light.

11. The reflective waveguide of claim 7, wherein the input hot mirror is implemented at one or more prisms of the substrate separate from the outcoupler.

12. The reflective waveguide of claim 11, further comprising another exit pupil expander configured to guide incoupled infrared light from the input hot mirror toward the eye-tracking outcoupler.

13. A near-eye display system comprising the reflective waveguide of claim 7, and further comprising:
an eye-tracking camera positioned at the eye-tracking outcoupler; and
one or more infrared light sources configured to illuminate an expected position of an eye of a user.

14. A near-eye display system comprising the reflective waveguide of claim 1, and further comprising:
an eye-tracking camera positioned at an eye-tracking outcoupler of the reflective waveguide; and
one or more infrared light sources configured to illuminate an expected position of an eye of a user.

15. The near-eye display system of claim 14, further comprising:
a processing system configured to determine a gaze direction of the eye of the user based on infrared imagery of the eye captured by the eye-tracking camera.

16. The near-eye display system of claim 15, further comprising:
a light engine positioned at the incoupler; and
wherein the processing system is configured to control the light engine based on the determined gaze direction.

17. A method for operating a near-eye display system comprising a reflective waveguide with an input hot mirror disposed at one or more partially-reflective prisms of the reflective waveguide, the input hot mirror reflective to infrared light and transmissive to visible light, the method comprising:
incoupling, using the input hot mirror, infrared light reflected from an eye of a user;
outcoupling the incoupled infrared light toward an eye-tracking camera via an eye-tracking outcoupler; and
controlling an operation of a near-eye display system based on a gaze direction determined from imagery of the eye captured by the eye-tracking camera.

18. The method of claim 17, further comprising:
incoupling display light from a light engine into the reflective waveguide via an incoupler;
guiding the incoupled display light to an outcoupler of the reflective waveguide via an exit pupil expander; and
outcoupling the incoupled display light toward the eye of the user via the outcoupler.

19. The method of claim 18, wherein the input hot mirror is implemented at one or more partially-reflective prisms of the outcoupler, and the method further comprises:
guiding the incoupled infrared light from the input hot mirror to the eye-tracking outcoupler via the exit pupil expander.

20. The method of claim 17, wherein the input hot mirror is a curved hot mirror configured to collimate the incoupled infrared light.
